(19) United States
(12) Patent Application Publication
(10) Pub. No.: US 2020/0042571 A1
(43) Pub. Date: Feb. 6, 2020

(54) DELAYED SPARSE MATRIX

(71) Applicant: Hirotaka NITSUMA, Okayama-shi Okayama (JP)

(72) Inventor: Hirotaka NITSUMA, Okayama-shi Okayama (JP)

(21) Appl. No.: 16/478,942

(22) PCT Filed: Jan. 18, 2018
(86) PCT No.: PCT/JP2018/001465

§ 371 Date: Jul. 18, 2019

(30) Foreign Application Priority Data
Jan. 19, 2017 (JP) 2017-007741

(51) Int. Cl. G06F 17/16

(52) U.S. Cl. CPC G06F 17/16

(57) ABSTRACT

A procedure for generating a matrix that is represented by a smaller amount of memory, said matrix being a solution for fitting, into memory, a computation involving matrix data that does not fit in memory. If matrix values are required, the memory usage is reduced by recomputing the values by performing a lazy evaluation of the procedure each time. The present invention is particularly effective in terms of correspondence analysis of a sparse matrix, and enables computations to be performed with the sparse matrix in an unchanged state, without storing a dense matrix, which is generated by a process for normalizing the sparse matrix, in memory. When a randomized singular value decomposition is used as a singular value decomposition, which is computed by the correspondence analysis, a technique enabling only the product of a base matrix and an arbitrary matrix to be computed by lazy evaluation may be used alone; thus the required memory need only be the amount of memory for the base sparse matrix. In the prior art, a significant amount of memory was required due to the transformation to a dense matrix in the process of the singular value decomposition computation.

### TECHNICAL FIELD

The present invention is a method of reducing the amount of memory used in a calculation which uses a matrix by expressing the matrix by delayed [lazy] evaluation.

### BACKGROUND TECHNOLOGY

Consider a 1000×1000 diagonal sparse matrix.

In the sparse matrix expression method of the previous art, when the diagonal elements are continuously the same elements 2,3,2,3,2,3, . . . , there must be a matrix of the size of 1000 to accommodate all the diagonal elements.
However, this matrix can be generated by a simple program.
Written in python code, for example, it can be expressed as

lambdai,j: (2 if i%2==0 else 3) if i==j else 0

If the (i,j) elements of the matrix are required, the matrix can be expressed by re-evaluating each procedure to obtain a value.
The character string of this matrix is very much smaller than a size 1000 matrix.
Thus, the amount of memory can be greatly reduced by expressing the matrix as a procedure, delay evaluating this procedure before use.
Since, however, this greatly increases computation time, use of the method is limited to specific implementations.
Since computation of big data has been carried out with greater frequency in recent years, however, there have been more opportunities for this method to be used effectively.

Consider a case when only the results of matrix product or other power iteration are required.

If the matrix product is regarded as a linear map, the results of the operation can be expressed by delayed evaluation of this linear map.
For example, if the result of vector x being applied to the above diagonal sparse matrix is written in python code, it is expressed as

lambdai,x: (2*x[i] if i%2==0 else 3*x[i])

and, similarly, it can be expressed using a much smaller memory.
The same can also be said of addition and other computations.

One method of expressing matrix computations by delayed evaluation is the method known as ‘expression templates’.

Expression templates is, however, a method used to reduce computation time and is not used to reduce memory use.
Since, conversely, the method described here increases computation time, it cannot be implemented just by using expression templates.

In recent years, calculation methods using video card GPUs have become more popular.

Video cards generally have only a small memory.
If the small memory of a GPU can accommodate the data of a large matrix, it is possible to perform calculations more rapidly than with a CPU.
The method described above, by which the amount of memory used is reduced by delayed evaluation, can be used for this.

By reducing memory use at an intermediate stage during computation, it may be possible to process big data, something which had previously been impossible.

One example is correspondence analysis.
The contingency table given as the input of correspondence analysis is generally a sparse matrix.
However, if we focus on the section where singular value decomposition is carried out at an intermediate stage in the computation, the matrix immediately before singular value decomposition is performed is always a dense matrix and this involves a great increase in memory use.

### Specifically

S=P−r*c·T

must be a dense matrix.
Here, when N is a python scipy library sparse matrix which expresses the contingency table, then:

P=N/N·sum()

r=P·sum(axis=1)

c=P·sum(axis=0)·T

Since r*c·T must be a dense matrix, S is a dense matrix even when N is a sparse matrix. In a case when N is a 1000×1000 diagonal sparse matrix, and the non-zero elements are no more than 1000 diagonal elements, S is a 1000×1000 dense matrix, and 1000-fold memory is required.
If this matrix S is expressed by the said delayed evaluation, it can be expressed by a memory usage approximately the same as the sparse matrix N of the contingency table. In a method such as randomized singular value decomposition, only matrix product is performed as an input matrix; when singular value decomposition is calculated, it is possible to use a matrix expressed by delayed evaluation of a matrix product. Specifically, when matrix product S*X is expressed by the delayed evaluation

lambdaX: P*X+r*(c·T*X)

it is possible to calculate the matrix product and singular value decomposition using approximately the same memory as the sparse matrix N of the contingency table.
Both calculation speed and memory load are improved.
When, for example, it is wished to find only the first 10 singular values, with N being a 1000×1000 diagonal sparse matrix, since only a 1000×10 size matrix can be expressed by X of the matrix product S*X, a memory usage of a 1000+1000×10 layout is adequate. If matrix S is expanded, a 1000×1000 layout memory is required, so that the memory usage is approximately 100-fold.

This may also be described as canonical correlation analysis or principal component analysis of sparse data.

### PRIOR ART REFERENCES

### Non-Patent References

Non-Patent Reference 1: expression templates

http://en.wikipedia.org/wiki/Expression templates

### SUMMARY OF THE INVENTION

### Problems the Invention Aims to Solve

The problems to be solved are the problems of computing by which matrix data that cannot be completely contained in the memory can be expressed.

### Means by which the Problems are Solved

A method characterised in that the memory usage is reduced by a matrix which cannot be completely contained in a memory being generated by a procedure using a smaller memory, this procedure itself being stored in the memory, and when the value of the matrix is required, the procedure being subjected to delayed evaluation each time and the value of the matrix generated; and a method in which the same method is used for matrix operations other than the matrix product.

This is characterised in that memory usage is reduced by a method whereby, when only the matrix product of a matrix that cannot be accommodated by a memory is required, only a matrix product procedure, which can be expressed by a smaller memory, is used, this procedure is stored in memory and the procedure is performed, and the computation results generated, when the results of this matrix product is required.

### Effects of the Invention

It becomes possible to carry out correspondence analysis, canonical correlation analysis and principal component analysis of sparse data which cannot be calculated due to intermediate results of calculation too large to be accommodated by the memory.

### EMBODIMENTS OF THE INVENTION

When a function which expresses a matrix operation, for example, operator functions such as

*,+
is realised such that it can be executed
when it operates on a matrix expressed by delayed evaluation,
by making a delayed valuation and expanding into a value,
without transcribing into program code such as randomized singular value decomposition or power iterations.

### Embodiment 1

In a randomized_svd function, which is an implementation of randomized singular value decomposition in the python scikit-learn-0.17.1 library, a matrix product can be carried out using a safe_sparse_dot function.

Singular value decomposition of the matrix expressed by delayed evaluation is made possible by expanding this safe_sparse_dot function, so that it can be used in a matrix expressed by delayed evaluation.

In the case of correspondence analysis when a contingency table is a sparse matrix, computation can be performed with a smaller memory by using the matrix S, described above, expressed by delayed evaluation, as the randomized_svd function expanded to this safe_sparse_dot function.

When contingency table N is a 1000×1000 diagonal sparse matrix, the memory usage is 1/1000.

1. An algorithm which performs sparse matrix calculations with good memory efficiency with almost no alteration to a matrix calculation program based on dense matrices, such as power iteration and randomized SVD (by additional definitions in respect of the objects of functions which delay evaluating operator overload of operators) for which, when sparse matrix computation is carried out as a section of another program, with almost no alteration to a matrix calculation program based on dense matrices, such as power iteration and randomized SVD, rewriting is performed to the object of a function which expresses the arithmetic processing section at which a sparse matrix is expanded at an intermediate stage of the calculation to become a dense matrix (for example, +function, which is the sum operation A+X of sparse matrix A and dense matrix X, is rewritten by the function object add_delay (A, X) which expresses the delay evaluation) and further, in respect of the section in which this result is used (for example, (A+X)*y, in which the result of the sum operation A+X of sparse matrix A and sparse matrix X is further multiplied by vector y), the operator for the type of object of the function of delay evaluation is newly defined and rewritten as a memory-efficient operation in which the sparse matrix is expanded with this newly defined operator without becoming a dense matrix (for example, when (A+X)*y is redefined as add_delay (A, X)*y, and on arrival of add_delay (U,V) type data, which expresses delayed evaluation by operator overload of product operation *, the rewriting is to a function by which sparse matrix A, which calculates in the order (A*y)+(X*y), is not expanded into a dense matrix) performing sparse matrix calculations with good memory efficiency with almost no alteration to a matrix calculation program premising dense matrices, such as power iteration and randomized SVD (by additional definitions in respect of the objects of functions which delayed evaluate operator overload of operators); and its implementation.

2. An algorithm which reduces the memory usage and calculation time and by which sparse matrix P is not expanded into a dense matrix, whereby, when calculations are performed using an algorithm, such as randomised SVD, used solely for multiplication of a matrix which it is wished to decompose, to calculate correspondence analysis which inputs sparse matrix data N as a contingency table, and the proportion of this, the place at which the difference between this proportion (hereinafter: matrix P=N/N·sum()) and the expected value of the contingency table (r*cT, as described in Background Technology [0006]) estimated from the average of the contingency table of the sparse matrix data (r=P·sum (axis=1) and c=P.sum (axis=0). T) as described in Background Technology [0006]), specifically the section as described in Background Technology [0006] in which S=P−r*c·T is calculated, is rewritten as a delayed evaluation function object according to claim 1 (for example, add_delay (P,−r*c·T)), product add_delay (P, −r*c·T)*y and z*add_delay (P,−r*c·T), using a function which calculates in the order (P*y)+(−r*(c·T*y)), and a function which calculates in the order (z*P)+(−(z*r)*c·T *y) as operator overloads for the delayed evaluation function object add_delay in an algorithm such as randomized SVD,

3. Canonical correlation analysis and principal component analysis which reduces memory usage, as in claim 2.

4. A method and algorithm according to claim 1, in which a tensor is used, and the implementation of this.

5. A method and algorithm according to claim 1, in which the memory usage is reduced and data is stored in a GPU memory, and the implementation of this.

6. A method and algorithm according to claim 2, in which the memory usage is reduced and data is stored in a GPU memory, and the implementation of this.

7. A method and algorithm according to claim 3, in which the memory usage is reduced and data is stored in a GPU memory, and the implementation of this.

8. A method and algorithm according to claim 4, in which the memory usage is reduced and data is stored in a GPU memory, and the implementation of this.
